(19) United States
(12) Patent Application Publication
(10) Pub. No.: US 2025/0132477 A1
(43) Pub. Date: Apr. 24, 2025

(54) BATTERY CELL AND SEALING APPARATUS FOR ELECTROLYTE INJECTION-HOLE OF BATTERY CELL

(71) Applicant: SK On Co., Ltd., Seoul (KR)

(72) Inventors: Dong Hyun SEO, Daejeon (KR); Yoo Seok JEONG, Daejeon (KR)

(21) Appl. No.: 18/906,172

(22) Filed: Oct. 4, 2024

(30) Foreign Application Priority Data
Oct. 23, 2023 (KR) 10-2023-0142013

(51) Int. Cl. H01M 50/645

(52) U.S. Cl. CPC H01M 50/645

(57) ABSTRACT

A battery cell includes a case including an accommodation space in which an electrode assembly is accommodated; a cap plate covering the accommodation space, and having an electrolyte injection port formed therein; a first sealing member inserted into the electrolyte injection port, and sealing the electrolyte injection port; and a second sealing member, at least a portion of which is accommodated in the first sealing member, and the second sealing member not in contact with the electrolyte injection port, wherein the first sealing member and the second sealing member are formed of a material including at least one of a resin and rubber.

### CROSS-REFERENCE TO RELATED APPLICATION(S)

This patent document claims the priority and benefits of Korean Patent Application No. 10-2023-0142013 filed on Oct. 23, 2023, the disclosure of which is incorporated herein by reference in its entirety.

### TECHNICAL FIELD

The present disclosure relates to a battery cell and a sealing apparatus for an electrolyte injection port of the battery cell.

### BACKGROUND

Batteries are widely used in small electronic devices such as mobile phones and laptop computers, as well as medium-to-large mechanical devices such as electric vehicles (EVs), and have the advantage of being chargeable and reusable.

If necessary, a battery module may be formed by stacking a plurality of battery cells, and a battery pack can be formed with a plurality of battery modules.

Battery cells constituting such batteries may be manufactured by storing an electrode assembly comprising a positive electrode plate, a negative electrode plate, and a separator in a case, injecting an electrolyte into the case, and then sealing the case.

For example, a prismatic battery cell may have an electrolyte injection port for injecting an electrolyte through a cap plate covering the case. Once electrolyte injection into the case is completed through the electrolyte injection port, the electrolyte injection port can be sealed.

If the electrolyte leaks to the outside of the case, it can not only cause fatal defects in the battery cells, but may also compromise the safety of the battery.

### SUMMARY

According to an aspect of the present disclosure, a battery cell in which electrolyte leakage is prevented is provided.

According to an aspect of the present disclosure, a battery cell having improved durability is provided.

According to an aspect of the present disclosure, a sealing apparatus for an electrolyte injection port of a battery cell having improved convenience and efficiency in an electrolyte sealing operation is provided.

In addition, the present disclosure may be widely applied to green technology fields such as solar power generation and wind power generation.

In addition, the present disclosure may be applied to eco-friendly devices such as eco-friendly electric vehicles and hybrid vehicles to help ameliorate the effects of climate change by suppressing air pollution and greenhouse gas emissions.

According to an aspect of the present disclosure, a battery cell includes a case including an accommodation space in which an electrode assembly is accommodated; a cap plate covering the accommodation space, and having an electrolyte injection port formed therein; first sealing member inserted into the electrolyte injection port and sealing the electrolyte injection port; and a second sealing member, at least a portion of which is accommodated in the first sealing member, and the second sealing member not in contact with the electrolyte injection port, wherein the first sealing member and the second sealing member may be formed of a material including at least one of a resin and rubber.

In an embodiment, the first sealing member is formed of a first material having a first heat deflection temperature, and has a first initial width at a temperature less than the first heat deflection temperature, wherein the first initial width decreases at a temperature higher than or equal to the first heat deflection temperature, and the second sealing member is formed of a second material having a second heat deflection temperature, and has a second width, wherein the first heat deflection temperature may be a value lower than the second heat deflection temperature, and the second width may be a value smaller than the first initial width.

In an embodiment, the second width may be a value less than 100% and greater than or equal to 90% of a third width, a width of the electrolyte injection port.

In an embodiment, the first heat deflection temperature may be a value higher than 40° C. and lower than or equal to 80° C., and the second heat deflection temperature may be a value higher than 100° C. and lower than or equal to 250° C.

In an embodiment, the first sealing member may have an external shape deformed at the first heat deflection temperature, and be cooled while in contact with the cap plate, and to have a first final width.

In an embodiment, the first initial width of the first sealing member may be a value higher than 100% and less than or equal to 120% of the third width.

In an embodiment, the second sealing member may have a cylindrical shape.

In an embodiment, at least one of one end and the other end of the second sealing member may protrude to the outside of the cap plate, and may be spaced apart from the cap plate by a first separation distance.

In an embodiment, the first sealing member may have a spherical shape including a coupling space therein, the first initial width may be a diameter of the first sealing member, and at least a portion of the second sealing portion may be exposed to the outside of the first sealing member.

In an embodiment, the first sealing member and the second sealing member may be formed as a single sealing member.

In an embodiment, the first sealing member and the second sealing member may be molded by double injection.

In an embodiment, the first sealing member and the second sealing member may be coupled to each other or separated from each other.

According to an aspect of the present disclosure, a sealing apparatus for an electrolyte injection port of a battery cell includes: a device body in which a first supply passage through which a first sealing member and a second sealing member accommodated in the first sealing member, an end of which is exposed to the outside of the first sealing member, move simultaneously and a second supply passage through which fluid moves, are formed; a support rod connected to the device body, and including a hollow portion connected to the first supply passage and the second supply passage; a supply nozzle connected to the support rod, having a third supply passage connected to the hollow portion formed therein, and including an outlet through which the first sealing member and the second sealing member are discharged; a heating member connected to the supply nozzle, and heating the supply nozzle; and a pressure supply member supplying fluid to the second supply passage when the supply nozzle is heated, wherein a width of the outlet may be a value smaller than a width of the first sealing member before flowing into the first supply passage.

In an embodiment, when the sealing apparatus for an electrolyte injection port of a battery cell is inserted into the hollow portion, and the supply nozzle is heated, the sealing apparatus for an electrolyte injection port of a battery cell may further include a pressing member pressing the second sealing member in the hollow portion to push the second sealing member toward the outlet.

In an embodiment, the heating member may be connected to the device body, and may surround an outer circumferential surface of the supply nozzle.

In an embodiment, the heating member may heat the supply nozzle so that the supply nozzle reaches a heat deflection temperature of the first sealing member, and the pressing member may press an end of the second sealing member in a direction toward the outlet.

In an embodiment, the sealing apparatus for an electrolyte injection port of a battery cell may further include a buffer member connected to the device body or the heating member.

In an embodiment, the sealing apparatus for an electrolyte injection port of a battery cell may further include a moving member connected to the device body, and moving the device body.

In an embodiment, the third supply passage includes an upper width section, a section having a value higher than 100% and less than or equal to 120% of a first initial width, the first initial width being a width of the first sealing member at a temperature less than the heat deflection temperature, and a width of the outlet may have a width value higher than or equal to 80% and less than 100% of the first initial width of the first sealing member.

In an embodiment, the supply nozzle and the device body may be coupled to each other or separated from each other.

### BRIEF DESCRIPTION OF DRAWINGS

Certain aspects, features, and advantages of the present disclosure are illustrated by the following detailed description with reference to the accompanying drawings.

FIG. 1 is a front cross-sectional view of a battery cell according to an embodiment of the present disclosure.

FIG. 2 is a perspective view of a first sealing member and a second sealing member according to an embodiment of the present disclosure.

FIG. 3 is an exploded perspective view of a first sealing member and a second sealing member according to another embodiment of the present disclosure.

FIG. 4 illustrates a state before the first sealing member and the second sealing member are inserted into the electrolyte injection port according to an embodiment of the present disclosure.

FIG. 5 illustrates a state in which the first sealing member and the second sealing member of FIG. 4 have been completely inserted into the electrolyte injection port.

FIG. 6 schematically illustrates a sealing apparatus for an electrolyte injection port of a battery cell according to an embodiment of the present disclosure.

FIG. 7 schematically illustrates a sealing apparatus for an electrolyte injection port of a battery cell according to another embodiment of the present disclosure.

FIG. 8 is a partial exploded view of illustrates a sealing apparatus for an electrolyte injection port of a battery cell according to another embodiment of the present disclosure.

FIG. 9 is a diagram illustrating an operating state of a illustrates a sealing apparatus for an electrolyte injection port of a battery cell according to an embodiment of the present disclosure.

FIG. 10 is a diagram illustrating an operating state of a illustrates a sealing apparatus for an electrolyte injection port of a battery cell according to another embodiment of the present disclosure.

FIG. 11 is an enlarged view of a supply nozzle according to an embodiment of the present disclosure.

FIG. 12 is a diagram illustrating an operating state of a sealing apparatus for an electrolyte injection port of a battery cell according to an embodiment of the present disclosure.

FIG. 13 is a diagram illustrating an operating state of a sealing apparatus for an electrolyte injection port of a battery cell according to an embodiment of the present disclosure.

### DETAILED DESCRIPTION

In order to facilitate understanding of the description of embodiments of the present disclosure, elements indicated with the same reference numerals in the attached drawings are the same elements. Some components in the attached drawings are exaggerated, omitted, or schematically shown, and the size of each component does not completely reflect the actual size thereof.

In addition, in order to clarify the gist of the present disclosure, descriptions of elements and techniques well known in the prior art will be omitted. Hereinafter, embodiments of the present disclosure will be described in detail with reference to the drawings.

However, the spirit of the present disclosure is not limited to the presented embodiments. A person skilled in the art who understands the spirit of the present invention may suggest other embodiments that are included within the scope of the spirit of the present disclosure through addition, change, or deletion of components, but this will also be included within the scope of the spirit of the present disclosure.

Hereinafter, an X-axis shown in the attached drawings is a width direction of the battery cell 100, a Y-axis is a height direction of the battery cell 100, and a Z-axis is a thickness direction of the battery cell 100. However, this is an arbitrarily set direction for convenience of explanation, and the direction shown may be changed depending on the specifications of the battery cell 100, the manufacturing environment of the battery cell, and the like.

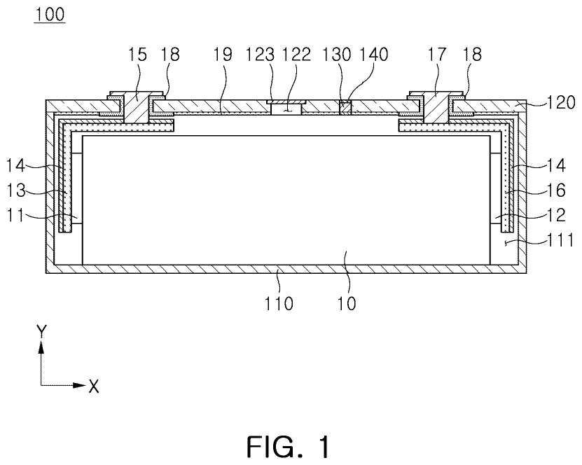

FIG. 1 is a front cross-sectional view of a battery cell 100 according to an embodiment of the present disclosure.

As shown in FIG. 1, the battery cell 100 includes a case 110 including an accommodation space 111 in which an electrode assembly 10 is accommodated, a cap plate 120 covering the accommodation space 111, and having an electrolyte injection port 121 formed therein, a first sealing member 130 inserted into the electrolyte injection port 121, and sealing the electrolyte injection port 121, and a second sealing member 140, at least a portion of which is accommodated in the first sealing member 130, and which is not in contact with the electrolyte injection port 121, wherein the first sealing member 130 and the second sealing member 140 may be formed of a material including at least one of a resin, rubber, and special rubber (or industrial specialty rubber).

The case 110 may be formed of aluminum, an aluminum alloy, or nickel-plated metal. The case 110 includes an accommodation space 111 therein, and the electrode assembly 10 can be accommodated in the accommodation space 111.

The electrode assembly 10 is comprised of a positive electrode plate, a negative electrode plate, and a separator, and a separator may be interposed between the positive electrode plate and the negative electrode plate. The electrode assembly 10 may be provided as a stack-type or a wound-type. In an embodiment, the positive electrode plate and the negative electrode plate may be provided in plural.

A first electrode lead 11 connected to the positive electrode plate may be connected to a first lead tab 13, and a second electrode lead 12 connected to the negative electrode plate may be connected to a second lead tab 16. The first lead tab 13 and the second lead tab 16 may respectively be provided with an insulating layer 14 to insulate the first lead tab 13 and the second lead tab 16 from an inner surface of the case 110.

A cap plate 120 may be provided on the top of the case 110 to cover the accommodation space 111. The cap plate 120 may be formed of the same material as the case 110, and may be laser welded to the case 110 and fixed to the case 110.

The cap plate 120 may be provided with a first terminal 15 electrically connected to the first electrode lead 11, and may be provided with a second terminal 17 electrically connected to the second electrode lead 12. A gasket 18 may be provided between the cap plate 120 and the first terminal 15, and a gasket 18 may also be provided between the cap plate 120 and the second terminal 17.

The gasket 18 may serve to seal a terminal hole formed in the cap plate 120 so that the first terminal 15 and the second terminal 17 penetrate therethrough, and to insulate the first and second terminals from the cap plate 120.

The first terminal 15 may be electrically connected to the first lead tab 13 in the accommodation space 111, and the second terminal 17 may be electrically connected to the second lead tab 16 in the accommodation space 111. In an embodiment, an insulating film 19 may be provided on the inner surface of the cap plate 120 to insulate the cap plate 120 from the electrode assembly 10.

A venting hole 122 may be provided between the first terminal 15 and the second terminal 17 in the cap plate 120. The venting hole 122 may be a hole penetrating through the cap plate 120. The venting hole 122 may be covered by a venting plate 123 under normal conditions. In an embodiment, a cutting line may be processed on the venting plate 123. The cutting line can facilitate fracture of the venting plate 123 when the pressure inside the accommodation space 111 increases and the venting plate 123 fractures.

An electrolyte injection port 121 may be provided in the cap plate 120. The electrolyte injection port 121 may be a hole penetrating through the cap plate 120. When the cap plate 120 is completely welded to the case 110, an electrolyte can be injected into the accommodation space 111 through the electrolyte injection port 121. When electrolyte injection is completed, the electrolyte injection port 121 can be sealed by inserting the first sealing member 130 and the second sealing member 140 into the electrolyte injection port 121. When the electrolyte injection port 121 is sealed by the first sealing member 130 and the second sealing member 140, the electrolyte present in the accommodation space 111 can be prevented from leaking out of the case 110.

In addition, when the electrolyte injection port 121 is sealed by the first sealing member 130 and the second sealing member 140, external air can be blocked from flowing into the accommodation space 111, and it can prevent moisture, foreign substances, or the like, from penetrating into the accommodation space 111.

Meanwhile, the above-described battery cell 100 corresponds to a unidirectional battery cell, but the principles of the present disclosure may be equally applied to the electrolyte injection port of a bidirectional battery cell. The unidirectional battery cell may have multiple electrode leads drawn out in the same direction from the case 110, whereas the bidirectional battery cell may have multiple electrode leads drawn out in different directions from the case 110.

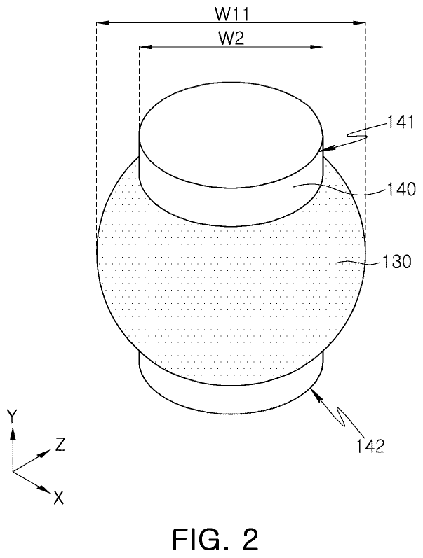

FIG. 2 is a perspective view of a first sealing member 130 and a second sealing member 140 according to an embodiment of the present disclosure.

In an embodiment, the first sealing member 130 may be formed of a material including a first material, and the second sealing member 140 may be formed of a material including a second material.

The first material and the second material may be materials with high physical properties in at least one of heat resistance, chemical resistance, durability, flame retardancy (or flame resistance or fire resistance), and moldability (or formability).

In an embodiment, the first material may be a resin having a first heat deflection temperature or a special rubber. In an embodiment, the special rubber may contain at least one of ethylene propylene rubber (ethylene propylene diene monomer, EPDM), Tetrafluoroethylene Propylene (FEPM), or urethane rubber. The first material may include at least one of the above-mentioned resin and special rubber.

In addition, in an embodiment, the first material may include at least one of silicone, fluoropolymer (or fluororesin), and polyurethane in addition to the materials described above.

The second material may be a resin having a second heat deflection temperature or a special rubber. In an embodiment, the special rubber may contain at least one of ethylene propylene rubber (ethylene propylene diene monomer, EPDM), Tetrafluoroethylene Propylene (FEPM), or urethane rubber. The second material may include at least one of the above-mentioned resin and special rubber.

In addition, in an embodiment, the second material may include at least one of silicone, fluoropolymer, and polyurethane in addition to the materials described above.

The first sealing member 130 and the second sealing member 140 may have different heat deflection temperatures. In an embodiment, the heat deflection temperature may be a deformation temperature under heat (or distortion-temperature under heat). As the first sealing member 130 is heated at a first heat deflection temperature, dimensions, shape, structure, and the like, of the first sealing member 130, including a diameter of the first sealing member 130, may be changed or modified, and as the second sealing member 140 is heated at a second heat deflection temperature, dimensions, shape, structure, and the like, of the second sealing member 140, including a diameter of the second sealing member 140, may be changed or modified.

In an embodiment, the first heat deflection temperature may be a value of higher than 40° C. and lower than or equal to 80° C. In addition, in an embodiment, the first heat deflection temperature may be 50° C. The second heat deflection temperature may have a higher value than the first heat deflection temperature. In an embodiment, the second heat deflection temperature may be a value higher than 100° C. and lower than or equal to 250° C.

The first sealing member 130 may have a first initial width W11 at a temperature lower than the first heat deflection temperature. The first initial width W11 may decrease at a temperature higher than or equal to the first heat deflection temperature. For example, when the first sealing member 130 is formed of a first material and the first deflection temperature of the first material is 50° C., a size, shape, structure, and the like, of the first sealing member 130 may change at a temperature of higher than or equal to 50° C. In this case, the value of 49° C. is also included in a temperature range of higher than 40° C. and lower than or equal to 80° C., but when the first material is selected as a material with a heat deflection temperature of 50° C., only the heat deflection temperature of the material selected as the first material may be the first heat deflection temperature. Therefore, the first sealing member 130 may begin to deform at a temperature higher than or equal to 50° C.

The fact that the range of the first heat distortion temperature is defined as being higher than 40° C. and lower than or equal to 80° C. should be understood that materials with a heat deflection temperature higher than 40° C. and lower than or equal to 80° C. among various materials may be selected as a first material. The same principle as described above can be applied to the second heat deflection temperature.

The first initial width W11 may be a width value of a region having the widest width in a cross-sectional shape of the first sealing member 130 in an X-Z plane. In an embodiment, when the first sealing member 130 has a spherical shape, the first initial width W11 may have a width value corresponding to a diameter of the first sealing member 130.

The second width W2 may have a width value smaller than the first initial width W11. The second width W2 may be a width value of a region having the widest width in a cross-sectional shape of the second sealing member 140 in an X-Z plane. In an embodiment, when the second sealing member 140 has a cylindrical shape, the second width W2 may be a width value corresponding to a diameter of the second sealing member 140.

In an embodiment, the first sealing member 130 may surround at least a portion of an outer circumferential surface (or outer surface) of the second sealing member 140, and the second sealing member 140 may have a shape in which at least a portion of the second sealing member 140 is accommodated in the first sealing member 130. At least one end of one end 141 and the other end 142 of the second sealing member 140 may be exposed to the outside of the first sealing member 130.

In addition, in an embodiment, the first sealing member 130 and the second sealing member 140 may be integrally provided. In an embodiment, the first sealing member 130 and the second sealing member 140 are formed as a single sealing member by double injection (or double injection method). For example, double injection may refer to an injection molding method in which a resin is injected into a secondary cavity space formed between a molded product that has been finished with first-stage molding and a mold, after placing the molded product back into the mold. To this end, the first sealing member 130 and the second sealing member 140 may be molded by double-injection (two shot injection molding). Double injection may cause the first sealing member 130 and the second sealing member 140 formed of different materials to be easily molded.

If the first sealing member 130 and the second sealing member 140 are molded by double injection and integrally provided, the bonding force between the first sealing member 130 and the second sealing member 140 can be improved, and the bonding force between the first sealing member 130 and the second sealing member 140 may be improved and it is possible to prevent a gap from forming between the sealing member 130 and the second sealing member 140. Therefore, it is possible to prevent the electrolyte from leaking between the first sealing member 130 and the second sealing member 140. In addition, the production efficiency of the first sealing member 130 and the second sealing member 140 can be improved.

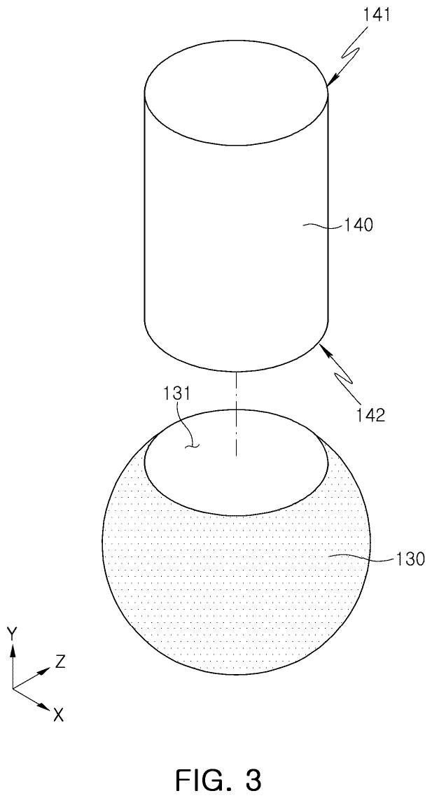

FIG. 3 is an exploded perspective view of a first sealing member 130 and a second sealing member 140 according to another embodiment of the present disclosure.

As shown in FIG. 3, the first sealing member 130 and the second sealing member 140 may be separately provided, and the second sealing member 140 may be provided to be coupled to the first sealing member 130 or separatable from the first sealing member 130. For example, the first sealing member 130 and the second sealing member 140 are configured to be detachable from each other.

In an embodiment, the first sealing member 130 may have a spherical shape having a coupling space therein, and the second sealing member 140 may have a cylindrical shape having a width corresponding to a width of the coupling space. The first sealing member 130 and the second sealing member 140 may be separately molded and coupled to each other and fixed. In this case, a separate sealing material, or the like may be applied to a coupling portion of the first sealing member 130 and the second sealing member 140.

The first sealing member 130 and the second sealing member 140 may be fittedly coupled to each other. In an embodiment, the first sealing member 130 and the second sealing member 140 may be provided to have a fitting tolerance of at least one of loose fit, intermediate fit, and interference fit.

The second sealing member 140, which has been fitted and coupled to the first sealing member 130, may have at least one end of one end 141 and the other end 142 thereof protruding to the outside of the first sealing member 130.

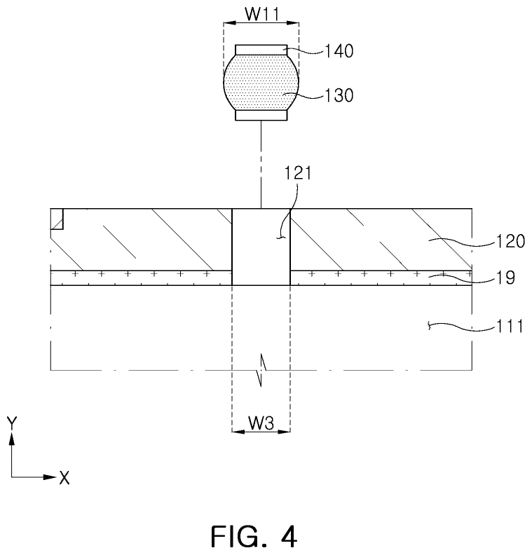

FIG. 4 illustrates a state before a first sealing member 130 and a second sealing member 140 are inserted into an electrolyte injection port 121 according to an embodiment of the present disclosure.

As shown in FIG. 4, the electrolyte injection port 121 is a hole penetrating the cap plate 120, and may have a third width W3 in a cross section thereof in an X-Y plane. The third width W3 may be lower than the first initial width W11 and higher than the second width (W2 in FIG. 2).

In an embodiment, the second width (W2 in FIG. 2) may have a width value less than 100% and greater than or equal to 90% of the third width W3, a width of the electrolyte injection port 121. Accordingly, even if some areas of the first sealing member 130 are deformed in an environment at a temperature higher than the first heat deflection temperature, the second sealing member 140 may serve to seal the electrolyte injection port 121 together with the remaining first sealing member 130.

Since the second sealing member 140 is accommodated inside the first sealing member 130, the width of the first sealing member 130 may have a closer relationship with the electrolyte injection port 121. In an embodiment, when the first initial width W11 corresponds to 101% of the third width W3 and the second width (W2 in FIG. 2) corresponds to 90% of the third width W3, the gap between the second sealing member 140 and the first sealing member 130 may be filled by reinforcing a thickness of the first sealing member 130. That is, a distance from an outer circumferential surface (or outer surface) of the second sealing member 140 to the outer circumferential surface (or outer surface) of the first sealing member 130 may correspond to the thickness of the first sealing member 130. In this case, when the first sealing member 130 has a spherical shape, the thickness of the first sealing member 130 may correspond to a thickness in a region in which the width of the first sealing member 130 is the widest in an X-Z (Z in FIG. 3) plane. According to this principle, the region between the outer circumferential surface of the second sealing member 140 and the outer circumferential surface of the first sealing member 130 may be filled with the first sealing member 130.

In addition, since the first sealing member 130 should exist continuously in a circumferential direction of the second sealing member 140, the second sealing member 140 may be accommodated in the first sealing member 130 so that centers of the first sealing member 130 and the second sealing member 140 in the X-Z (Z in FIG. 3) plane coincide with each other.

Meanwhile, the first sealing member 130 may have a first initial width W11 before being inserted into the electrolyte injection port 121 and at a temperature lower than the first heat deflection temperature. In an embodiment, the first initial width W11 may have a width value higher than 100% but less than or equal to 120% of the third width W3. According to this, when the first sealing member 130 is completely inserted into the electrolyte injection port 121, the first sealing member 130 may fill the gap between the second sealing member 140 and the electrolyte injection port 121, so that the electrolyte present inside the accommodation space 111 may be prevented from leaking to the outside of the battery cell. In addition, according to this, it is possible to prevent the first sealing member 130 from being provided excessively, and the first sealing member 130 can be provided in an appropriate amount. If the first sealing member 130 is provided in an appropriate amount without being excessive, it is possible to prevent the first sealing member 130 from overflowing to the outside of the electrolyte injection port 121.

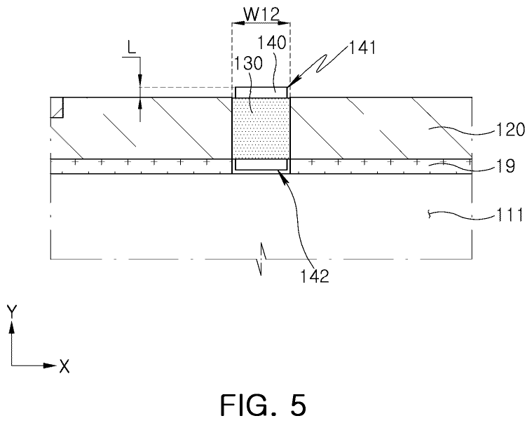

FIG. 5 illustrates a state in which the first sealing member 130 and the second sealing member 140 of FIG. 4 are inserted into an electrolyte injection port 121.

The first sealing member 130 may be heated to a temperature higher than or equal to the first heat deflection temperature and begin to be inserted into the electrolyte injection port (121 in FIG. 4) in a state in which at least some regions are deformed. In this case, the operation of heating the first sealing member 130 may not be performed at a temperature which completely melts the first sealing member 130, but at a temperature that can maintain a state in which an external shape of the first sealing member 130 is deformed but the first sealing member 130 may maintain a viscosity above a certain level to surround the outer circumferential surface (outer surface) of the second sealing member 140.

The first sealing member 130 may be inserted into the electrolyte injection port (121 in FIG. 4) and cooled while in contact with the cap plate 120.

In order to insert the first sealing member 130 and the second sealing member 140 into the electrolyte injection port (121 in FIG. 4), the first sealing member 130 may be heated to a temperature higher than or equal to the first heat deflection temperature but lower than the second heat deflection temperature. Therefore, thermal deformation of the second sealing member 140 does not occur.

The region in which the thermal deformation has occurred in the first sealing member 130 begins to cool when it comes into contact with the cap plate 120. In this case, the first sealing member 130 adheres to the cap plate 120 and may serve to increase the adhesion and coupling force between the first sealing member 130 and the second sealing member 140 and the cap plate 120.

In addition, since the first sealing member 130 adheres to the cap plate 120, it is possible to prevent the first sealing member 130 and the second sealing member 140 from flowing into the accommodation space 111. In addition, the sealing force of the electrolyte injection port 121 may be improved to effectively prevent electrolyte leakage, and as electrolyte leakage is prevented, the durability of the battery cell may also be improved.

In addition, when the electrolyte injection port 121 is sealed by the first sealing member 130 and the second sealing member 140, external air may be blocked from flowing into the accommodation space 111, and it is possible to prevent moisture, foreign substances, and the like, from penetrating into the accommodation space 111.

Meanwhile, the cooled first sealing member 130 may have a first final width W12 inside the electrolyte injection port (121 in FIG. 4). The first final width W12 is a width value smaller than the first initial width (W11 in FIG. 4), and may have a width value reduced by a width value higher than 0% but less than 10% of the first initial width W11. Since a weight of the first sealing member 130 is not lost at the electrolyte injection port (121 in FIG. 4), a length of the first sealing member 130 in the Y-axis direction may be increased as the thickness of the first sealing member 130 is reduced.

At least one end of the one end 141 and the other end 142 of the second sealing member 140 that has been inserted into the electrolyte injection port (121 in FIG. 4) may be exposed to the outside of the electrolyte injection port (121 in FIG. 4) and may protrude to the outside of the electrolyte injection port (121 in FIG. 4). Accordingly, the protruding region of the second sealing member 140 can be visually confirmed.

Therefore, it can be visually confirmed whether the first sealing member 130 and the second sealing member 140 have been properly inserted into the electrolyte injection port (121 in FIG. 4). In an embodiment, a sealing state of the electrolyte injection port (121 in FIG. 4) may be automatically confirmed through a sensor (not shown) sensing the protruding region of the second sealing member 140. This can contribute to improving battery cell assembly operation efficiency and productivity.

In an embodiment, the sensor may be a contact sensor, a non-contact sensor, or the like. An example of the contact sensor may be a linear variable differential transformer (LVDT), and an example of the non-contact sensor may be a laser displacement sensor.

In an embodiment, one end 141 of the second sealing member 140 may be spaced apart from an outer circumferential surface of the cap plate 120 by a first separation distance L. The first separation distance L may be a value greater than 0 mm and less than or equal to 2 mm. In addition, in an embodiment, the first separation distance L may be 1 mm. Accordingly, it is possible to easily check a sealing state of the electrolyte injection port (121 in FIG. 4) while preventing an increase in a volume of the battery cell more than necessary. Preventing an unnecessary volume increase of battery cells may contribute to improving energy density in future battery modules and battery pack units.

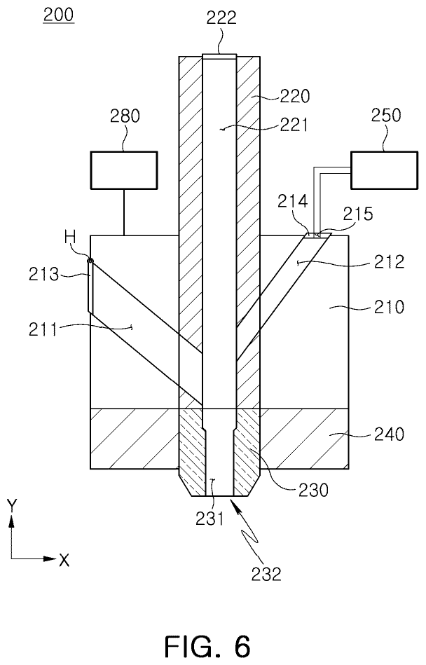

FIG. 6 schematically illustrates a sealing apparatus of an electrolyte injection port of a battery cell according to an embodiment of the present disclosure.

As shown in FIG. 6, in the present disclosure, as an apparatus for sealing an electrolyte injection port 121 of a battery cell, a sealing apparatus of an electrolyte injection port 200 inserting the first sealing member (130 in FIG. 5) and the second sealing member (140 in FIG. 5) into the electrolyte injection port 121 is provided.

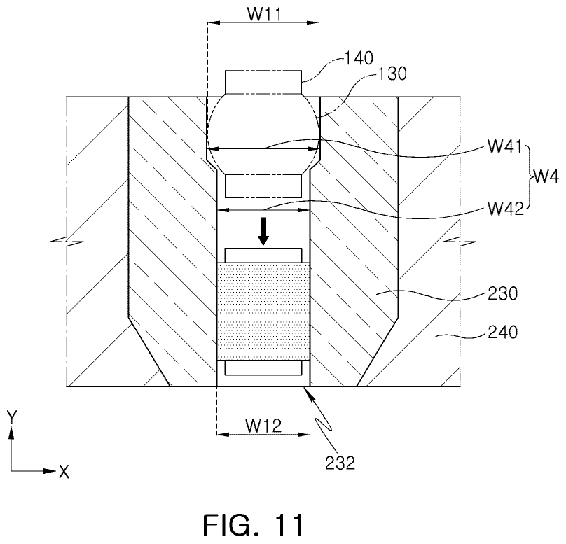

The sealing apparatus of an electrolyte injection port of a battery cell 200 includes a device body 210 in which a first supply passage 211 through which a first sealing member (130 in FIG. 5) and a second sealing member (140 in FIG. 5) accommodated inside the first sealing member (130 in FIG. 5), an end of which is exposed to the outside of the first sealing member (130 in FIG. 5) move simultaneously, and a second supply passage 212 through which fluid flows, are formed, a support rod 220 connected to the device body 210, and including a hollow portion 221 connected to the first supply passage 211 and the second supply passage 212, a supply nozzle 230 connected to the support rod 220, having a third supply passage 231 connected to the hollow portion 221 formed therein, and including an outlet 232 through which the first sealing member (130 in FIG. 5) and the second sealing member (140 in FIG. 5) are discharged, a heating member 240 connected to the supply nozzle 230 and heating the supply nozzle 230, and a pressure supply member 250 supplying fluid to the second supply passage 212, when the supply nozzle 230 is heated, wherein a width (X-axis direction) of the outlet 232 may be a width value smaller than the width of the first sealing member (130 in FIG. 5). The width of the outlet 232 may be the same as that of the lower width section (W42 in FIG. 11) of the supply nozzle 230.

A first supply passage 211 and a second supply passage 212 may be formed inside the device body 210, and the first supply passage 211 and the second supply passage 212 may have an empty interior thereof. A first sealing member (130 in FIG. 5) and a second sealing member (140 in FIG. 5) may be supplied to the first supply passage 211, and fluid may be supplied to the second supply passage 212. The first supply passage 211 may be provided to be inclined in a direction of gravity to facilitate the movement of the first sealing member (130 in FIG. 5) and the second sealing member (140 in FIG. 5) by gravity.

The device body 210 may include a first stopper 213 and a second stopper 214 that can seal a region in which the first supply passage 211 and the second supply passage 212 communicate with the outside of the device body 210. The first stopper 213 seals the first supply passage 211, and may be coupled to the device body 210 by a hinge (H). Therefore, the first stopper 213 can be opened or closed as needed. The second stopper 214 may seal the second supply passage 212 and may include a sub-passage 215 therein.

The pressure supply member 250 may be connected to the second supply passage 212 through the second stopper 214. The sub-passage 215 may be used as a passage through which the pressure supply member 250 supplies fluid to the second supply passage 212. The second stopper 214 may serve to prevent the fluid from escaping to the outside of the second supply passage 212 and reducing the pressure of the fluid.

In another embodiment of the present disclosure, the first stopper 213 may be replaced with a valve and applied. The application form of the first stopper 213 is not necessarily limited by the present disclosure, and may be replaced with other components within the range of enabling opening and closing of the first supply passage 211 and applied.

The pressure supply member 250 may supply fluid, such as air, or the like, to the second supply passage 212, and may be connected to the sub-passage 215 through a pipe or the like.

The support rod 220 may include a hollow portion 221 therein. The support rod 220 may be provided with a third stopper 222, and the third stopper 222 may seal a region in which the hollow portion 221 communicates with the outside of the support rod 220. The hollow portion 221 of the support rod 220 may be connected to the first supply passage 211 and the second supply passage 212.

A supply nozzle 230 may be connected to the bottom of the support rod 220. The supply nozzle 230 may include a third supply passage 231 therein. The third supply passage 231 may be coupled to the bottom of the support rod 220 to be connected to the hollow portion 221 of the support rod 220.

An outer circumferential surface of the supply nozzle 230 may be surrounded by a heating member 240. The supply nozzle 230 may be formed of a metal material, and may have a heat deflection temperature higher than that of the first sealing member (130 in FIG. 5) and the second sealing member (140 in FIG. 5). By surrounding the supply nozzle 230 with a heating member 240, heat transfer efficiency can be improved while minimizing heat loss.

The supply nozzle 230 includes an outlet 232 at the end thereof, and a width of the outlet 232 may have a width value smaller than a width of the first sealing member (130 in FIG. 5). In this case, the width of the first sealing member (130 in FIG. 5) may be a first initial width (W11 in FIG. 2), a width before the first sealing member (130 in FIG. 5) is heated. That is, the width of the outlet 232 may have a width value smaller than the first initial width (W11 in FIG. 2) of the first sealing member (130 in FIG. 2). In an embodiment, the width of the outlet 232 may have a width value greater than or equal to 90% and less than 100% of the first initial width (W11 in FIG. 2) of the first sealing member (130 in FIG. 2).

In an embodiment, a temperature measuring member (not shown) may be connected to the supply nozzle 230 to measure temperature information of the supply nozzle 230.

The heating member 240 may be fixed to the bottom of the device body 210, and may be disposed to surround at least a portion of the outer circumferential surface of the supply nozzle 230. The heating member 240 may be provided in the form of a heater cartridge, heat sink, and the like. The heating member 240 may be connected to a control means (not shown), so that whether the operation is performed, a heating temperature, and the like, may be automatically controlled. In an embodiment, a heat insulating member (not shown) may be provided on at least a portion of the outer circumferential surface of the heating member 240, that is, a portion which is not in contact with the supply nozzle 230.

A moving member 280 may be connected to one side of the device body 210. The moving member 280 may serve to move the device body 210, and a cylinder, robot arm, and the like, may be applied. This is not necessarily limited by the present disclosure, and may be appropriately selected and applied depending on the operator and work environment.

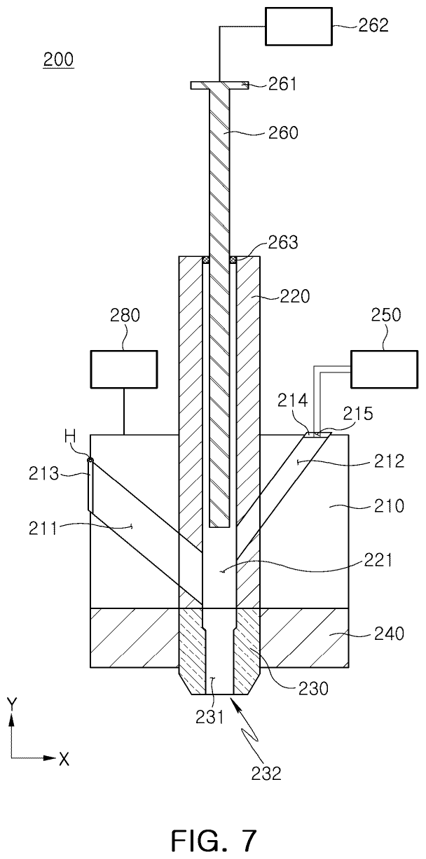

FIG. 7 schematically illustrates a sealing apparatus of an electrolyte injection port of a battery cell according to another embodiment of the present disclosure.

As shown in FIG. 7, a pressing member 260 may be further provided in a hollow portion 221 of a support rod 220. A width of the pressing member 260 may have a width value smaller than the width of the hollow portion 221, and the pressing member 260 may be provided to move in the hollow portion 221. In an embodiment, a pressure pusher 262 may be connected to the pressure member 260. The pressure pusher 262 may provide power to move the pressure member 260. The pressure pusher 262 may be a cylinder, a robot arm, and the like, but this is not necessarily limited by the present disclosure, and may be appropriately selected and applied depending on the operator and work environment.

In another embodiment of the present disclosure, the pressing pusher 262 may be connected to the pressure supply member 250 and receive compressed air from the pressure supply member 250.

A bearing 263 may be provided on the outer circumferential surface of the pressing member 260. The bearing 263 may serve to prevent friction with the support rod 220, when the pressing member 260 moves. By disposing a separate sealing member in a coupling portion between the support rod 220 and the bearing 263, the fluid supplied by the pressure supply member 250 may be prevented from leaking to the outside of the support rod 220.

In an embodiment, both ends of the pressing member 260 may extend in a direction opposite to the center of the pressing member 260 to form a stopper 261. The stopper 261 can prevent the pressing member 260 from flowing into the support rod 220, when the pressing member 260 moves in the −Y direction

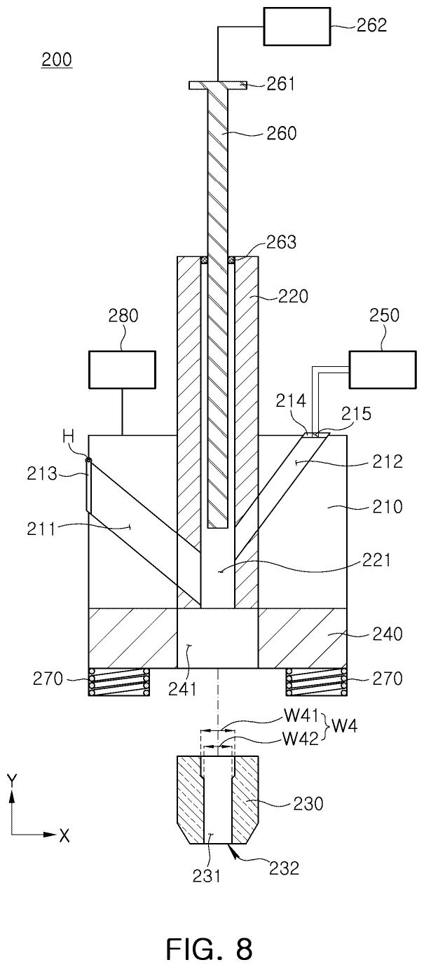

FIG. 8 is a partial exploded view of a sealing apparatus of an electrolyte injection port of a battery cell according to another embodiment of the present disclosure.

As shown in FIG. 8, the supply nozzle 230 may be detachably provided from the device body 210. For example, the supply nozzle 230 and the device body 210 are configured to be detachable from each other. In an embodiment, the heating member 240 may include a nozzle coupling space 241, and the supply nozzle 230 may be located in the nozzle coupling space 241. The supply nozzle 230 can be coupled to the device body 210 in the nozzle coupling space 241.

The supply nozzle 230 may be coupled to the device body 210 by fastening a bolt, or the like, to the supply nozzle 230 and the device body 210, and the supply nozzle 230 may be separated from the device body 230 by disassembling the bolt. According to this, maintenance work on the supply nozzle 230 can be easily performed, and only the supply nozzle 230 can be selectively replaced when necessary, thereby extending the lifespan of the device.

In an embodiment, a buffer member 270 may be coupled to the bottom of the heating member 240. The buffer member 270 may be formed of a material having elasticity. In an embodiment, the buffer member 270 may include a spring, rubber, and the like. A heat insulating member may be disposed in a coupling region of the heating member 240 and the buffer member 270.

The buffer member 270 may contribute to extending the lifespan of the device by reducing the impact applied to the heating member 240, the device body 210, and the support rod 220 during the sealing operation. In addition, if rubber, or the like, is applied to the outer circumferential surface of the buffer member 270, when it comes into contact with the battery cell later, it can prevent scratches on the surface of the battery cell.

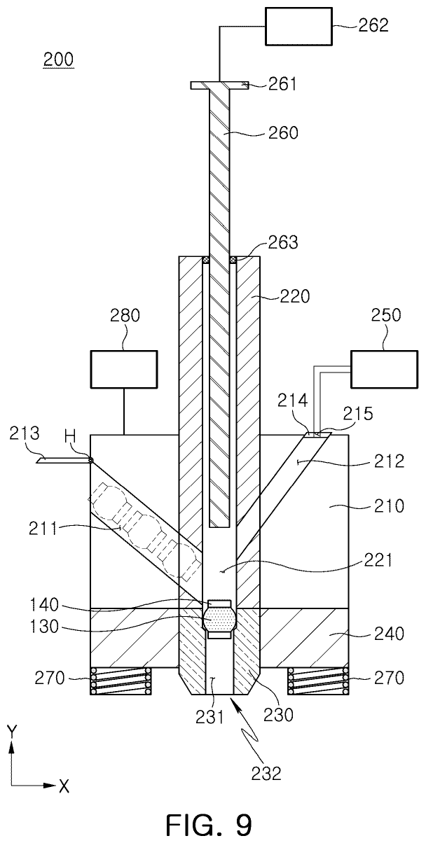

FIG. 9 is a diagram illustrating an operating state of a sealing apparatus for an electrolyte injection port of a battery cell according to an embodiment of the present disclosure.

As shown in FIG. 9, the first sealing member 130 and the second sealing member 140, which are fixed to each other, may be inserted into the first supply passage 211. To this end, by opening the first stopper 213, the first supply passage 211 may be opened.

The first sealing member 130 and the second sealing member 140 inserted into the hollow portion 221 from the first supply passage 211 may exist in the third supply passage 231 of the supply nozzle 230. The first sealing member 130 may contact an inner surface of the supply nozzle 230 in the third supply passage 231, and may be heated by the supply nozzle 230.

To this end, the heating member 240 may heat the supply nozzle 230, and the heating member 240 may also preheat the supply nozzle 230 to a preset temperature before the first sealing member 130 and the second sealing member 140 are inserted.

The heating member 240 may heat the supply nozzle 230 at a temperature satisfying both conditions, in more detail, one of the conditions is that the heating member 240 may heat the supply nozzle 230 at a temperature above the first heat deflection temperature of the first sealing member 130, and the other one of the conditions is that the heating member 240 may heat the supply nozzle 230 so that a viscosity of the first sealing member 130 is lower than that at a temperature having the first initial width (W11 in FIG. 4). When the heating member 240 satisfies all of the above-mentioned conditions and at the same time, the first sealing member 130 reaches a point in which the first sealing member 130 exceeds solid properties (e.g., a temperature that exceeds solid properties), heating of the supply nozzle 230 may be stopped or the heating intensity thereof may be reduced.

When an external shape of the first sealing member 130 begins to deform, the pressure supply member 250 may supply fluid to cause the first sealing member 130 and the second sealing member 140 to move in a −Y direction.

When the external shape of the first sealing member 130 is deformed, the width of the first sealing member 130 decreases, so the first sealing member 130 and the second sealing member 140 may be moved in the −Y direction to a position close to the outlet 232. In this case, the pressure caused by the fluid applied from the pressure supply member 250 may help the first sealing member 130 and the second sealing member 140 be discharged to the outside of the outlet 232. In an embodiment, a pressure measurement gauge may be provided in the second supply passage 212 or the third supply passage 231.

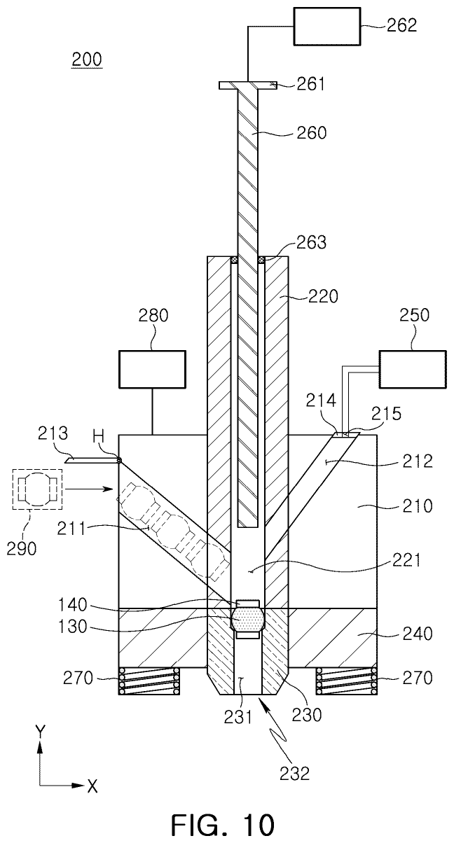

FIG. 10 is a diagram illustrating an operating state of a sealing apparatus of an electrolyte injection port of a battery cell according to another embodiment of the present disclosure.

A sealing member supply unit 290 automatically supplying the first sealing member 130 and the second sealing member 140 may be connected to the first supply passage 211. According to this, the first sealing member 130 and the second sealing member 140 can be automatically supplied, thereby improving the convenience and efficiency of operation.

FIG. 11 is an enlarged view of the supply nozzle 230 according to an embodiment of the present disclosure.

A width W4 of a third supply passage 231 formed inside the supply nozzle 230 may be variable. The width W4 of the third supply passage 231 may have a wide width value at the upper end thereof, but may decrease as it approaches the outlet 232.

In an embodiment, the third supply passage 231 may have an upper width section W41 at the top and a lower width section W42 at the bottom. According to the upper width section W41, a contact time of the first sealing member 130 with an inner circumferential surface of the supply nozzle 230 may be maintained for a certain period of time or more. Therefore, it is possible to secure a time for the first sealing member 130 to be heated to an appropriate temperature.

The lower width section W42 may be equal to the width of the outlet 232. The upper width section W41 may have a width of an injection port through which the first sealing member 130 and the second sealing member 140 flow. The upper width section W41 may have a width value greater than or equal to the first initial width W11 of the first sealing member 130. In an embodiment, the upper width section W41 may have a width value higher than 100% and less than or equal to 120% of the first initial width W11 of the first sealing member 130. According to this, a sufficient time for the first sealing member 130 to contact the inner circumferential surface of the supply nozzle 230 can be secured.

The lower width section W42 may be the same as the width of the outlet 232, and may be a width value of greater than or equal to 80% and less than 100% of the first initial width W11 of the first sealing member 130. In an embodiment, the lower width section W42 may have a width value corresponding to 85% of the first initial width W11 of the first sealing member 130. If the width of the outlet 232 and the value of the lower width section W42 are set to a value corresponding to 85% of the first initial width W11, the first sealing member 130 may be discharged to the outside of the supply nozzle 230 with minimal friction with the inner circumferential surface of the supply nozzle 230.

As described above, when the heating member 240 begins the heating operation and the inner circumferential surface of the supply nozzle 230 reaches the first heat deflection temperature of the first sealing member 130, the external shape of the first sealing member 130 begins to deform. As the temperature of the inner circumferential surface of the supply nozzle 230 gradually increases, the first initial width W11 of the first sealing member 130 may decrease, so that the first sealing member 130 and the second sealing member 140 may be reduced so that the first sealing member 130 and the second sealing member 140 may gradually move in the −Y direction along the inner circumferential surface of the supply nozzle 230. When the width of the first sealing member 130 becomes the first final width W12, the first sealing member 130 may be discharged to the outside of the outlet 232.

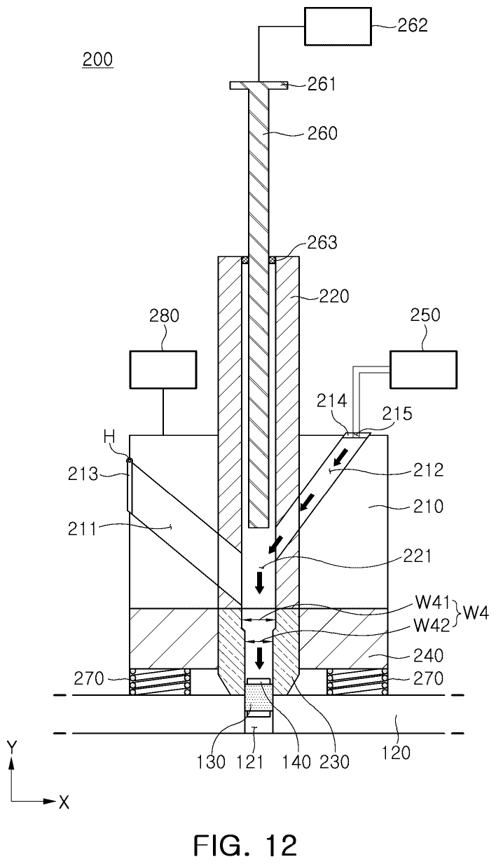

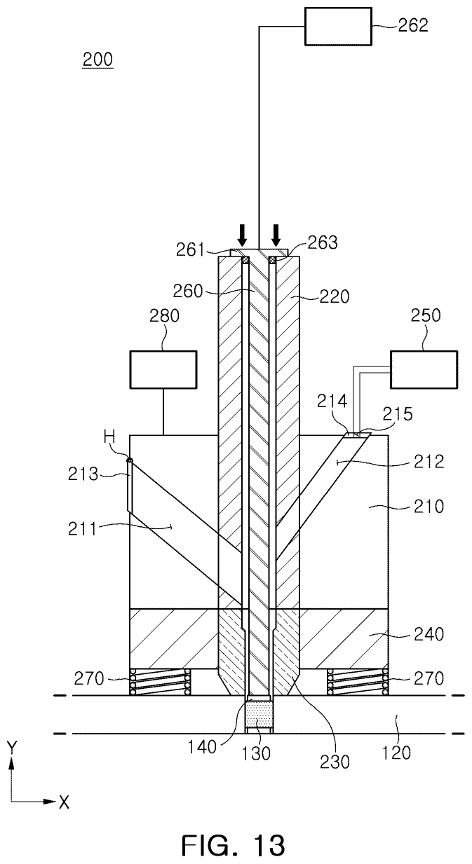

FIGS. 12 and 13 are diagrams illustrating an operating state of a sealing apparatus for an electrolyte injection port of a battery cell according to an embodiment of the present disclosure.

When the heating member 240 initiates heating of the supply nozzle 230 and the first sealing member 130 is deformed beyond a certain level, the moving member 280 may move the device body 210 to bring the buffer member 270 into contact with the cap plate 120. The heating member 240 can heat the supply nozzle 230 by the above-described method, and a width of the heated first sealing member 130 may be reduced to a certain level. The operation of heating the supply nozzle 230 by the heating member 240 may be performed in a state in which the supply nozzle 230 does not face the electrolyte injection port 121. Accordingly, it is possible to prevent the cap plate 120 or the electrolyte injection port 121 from being damaged by heat.

When the first sealing member 130 is thermally deformed beyond a certain level, the heating member 240 may stop heating the supply nozzle 230. In a state in which the first sealing member 130 is thermally deformed to a level to which it has a viscosity sufficient to flow along the supply nozzle 230, the outlet 232 of the supply nozzle 230 may face the electrolyte injection port 121 of the cap plate 120.

Thereafter, the pressure supply member 250 may supply fluid to help the first sealing member 130 and the second sealing member 140 move in a −Y direction. As a result, at least portions of the first sealing member 130 and the second sealing member 140 may be inserted into the electrolyte injection port 121.

In an embodiment, if the width of the supply nozzle 230 is provided to be wider than the width of the electrolyte injection port 121 by a certain level, the supply nozzle 230 may be supported by the cap plate 120. Therefore, only the first sealing member 130 and the second sealing member 140 may be inserted into the electrolyte injection port.

Meanwhile, when the first sealing member 130 is deformed beyond a certain level, the pressure pusher 262 can move the pressure member 260 in the −Y direction. The pressing member 260 may press the second sealing member 140 to completely discharge the first sealing member 130 and the second sealing member 140 to the outside of the supply nozzle 230. Then, the first sealing member 130 and the second sealing member 140 may be completely inserted into the electrolyte injection port. The first sealing member 130 adheres to an inner surface of the cap plate 120, and can be cooled while in contact with the cap plate 120. As a result, a sealing operation of the electrolyte injection port using the first sealing member 130 and the second sealing member 140 may be completed.

The content described above is merely an example of applying the principles of the present disclosure, and other configurations may be further included without departing from the scope of the present disclosure.

As set forth above, according to the present disclosure, electrolyte leakage of a battery cell can be prevented.

According to the present disclosure, durability of a battery cell can be improved.

According to the present disclosure, the convenience and efficiency of a sealing operation for an electrolyte injection port of a battery cell can be improved.

According to the present disclosure, the convenience and efficiency of a sealing operation for an electrolyte injection port of a battery cell can be improved.

In addition, the present disclosure can be applied to eco-friendly devices such as eco-friendly electric vehicles, hybrid vehicles, and the like, to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

While exemplary embodiments have been illustrated and described above, it will be apparent to those skilled in the art that modifications and variations could be made without departing from the scope of the present invention as defined by the appended claims.

What is claimed is:

1. A battery cell, comprising:
a case including an accommodation space in which an electrode assembly is accommodated;
a cap plate covering the accommodation space, and having an electrolyte injection port formed therein;
a first sealing member inserted into the electrolyte injection port, and sealing the electrolyte injection port; and
a second sealing member, at least a portion of which is accommodated in the first sealing member, and the second sealing member not in contact with the electrolyte injection port,
wherein the first sealing member and the second sealing member are formed of a material including at least one of a resin and rubber.

2. The battery cell of claim 1, wherein the first sealing member is formed of a first material having a first heat deflection temperature, has a first initial width at a temperature less than the first heat deflection temperature, wherein the first initial width decreases at a temperature higher than or equal to the first heat deflection temperature,
the second sealing member is formed of a second material having a second heat deflection temperature, and has a second width,
the first heat deflection temperature is a value lower than the second heat deflection temperature, and
the second width is a value smaller than the first initial width.

3. The battery cell of claim 2, wherein the second width is a value less than 100% and greater than or equal to 90% of a third width, a width of the electrolyte injection port.

4. The battery cell of claim 3, wherein the first sealing member has an external shape deformed at the first heat deflection temperature, and is cooled while in contact with the cap plate, and to have a first final width.

5. The battery cell of claim 4, wherein the first initial width of the first sealing member is a value greater than 100% and less than or equal to 120% of the third width.

6. The battery cell of claim 2, wherein the second sealing member has a cylindrical shape.

7. The battery cell of claim 2, wherein at least one of one end and the other end of the second sealing member protrudes to the outside of the cap plate, and is spaced apart from the cap plate by a first separation distance.

8. The battery cell of claim 2, wherein the first sealing member has a spherical shape including a coupling space therein, and the first initial width is a diameter of the first sealing member, and
the second sealing member has at least a portion exposed to the outside of the first sealing member.

9. The battery cell of claim 2, wherein the first sealing member and the second sealing member are formed as a single sealing member.

10. The battery cell of claim 9, wherein the first sealing member and the second sealing member are molded by double injection.

11. The battery cell of claim 2, wherein the first sealing member and the second sealing member are coupled to each other and separated from each other.

12. A sealing apparatus for an electrolyte injection port of a battery cell, comprising:
a device body in which a first supply passage through which a first sealing member and a second sealing member accommodated inside the first sealing member, an end of which is exposed to the outside of the first sealing member, move simultaneously, and a second supply passage through which fluid moves, are formed;
a support rod connected to the device body, and including a hollow portion connected to the first supply passage and the second supply passage;
a supply nozzle connected to the support rod, having a third supply passage connected to the hollow portion formed therein, and including an outlet through which the first sealing member and the second sealing member are discharged;
a heating member connected to the supply nozzle, and heating the supply nozzle; and
a pressure supply member supplying fluid to the second supply passage when the supply nozzle is heated,
wherein a width of the outlet is a value, smaller than a width of the first sealing member before flowing into the first supply passage.

13. The sealing apparatus for an electrolyte injection port of a battery cell of claim 12, further comprising:
a pressing member inserted into the hollow portion, and presses the second sealing member in the hollow portion when the supply nozzle is heated to push the second sealing member toward the outlet.

14. The sealing apparatus for an electrolyte injection port of a battery cell of claim 12, wherein the heating member is connected to the device body, and surrounds an outer circumferential surface of the supply nozzle.

15. The sealing apparatus for an electrolyte injection port of a battery cell of claim 13, wherein the heating member heats the supply nozzle so that the supply nozzle reaches a heat deflection temperature of the first sealing member, and
the pressing member presses an end of the second sealing member in a direction toward the outlet.

16. The sealing apparatus for an electrolyte injection port of a battery cell of claim 12, further comprising:
a buffer member connected to the device body or the heating member.

17. The sealing apparatus for an electrolyte injection port of a battery cell of claim 12, further comprising:
a moving member connected to the device body, and moving the device body.

18. The sealing apparatus for an electrolyte injection port of a battery cell of claim 15, wherein the third supply passage comprises
an upper width section, a section having a value higher than 100% and less than or equal to 120% of a first initial width, the first initial width being a width of the first sealing member at a temperature less than the heat deflection temperature, and
the width of the outlet is a value higher than or equal to 80% and less than 100% of the first initial width of the first sealing member.

19. The sealing apparatus for an electrolyte injection port of a battery cell of claim 12, wherein the supply nozzle and the device body are coupled to each other and separated from each other.
